(19) United States
(12) Patent Application Publication
(10) Pub. No.: US 2011/0039685 A1
(43) Pub. Date: Feb. 17, 2011

(54) TRANSPARENT ALUMINA CERAMICS WITH ORIENTED GRAINS AND PREPARATION METHOD THEREOF

(75) Inventors: Xiaojian MAO, Shanghai (CN); Shiwei WANG, Shanghai (CN); Shunzo SHIMAI, Shanghai (CN)

Correspondence Address: HAMRE, SCHUMANN, MUELLER & LARSON, P.C., P.O. BOX 2902, MINNEAPOLIS, MN, 55402-0902, US

(73) Assignee: Shanghai Institute of Ceramics, Chinese Academy of Sciences, Shanghai (CN)

(21) Appl. No.: 12/824,776

(22) Filed: Jun. 28, 2010

Related U.S. Application Data
(63) Continuation-in-part of application No. PCT/CN2008/073749, filed on Dec. 26, 2008.

(30) Foreign Application Priority Data
Dec. 26, 2007 (CN) 200710173112.7

(51) Int. Cl. C04B 35/44; C01F 7/02; B28B 1/26; B28B 1/00; B28B 11/24; B29C 35/08

(52) U.S. Cl. 501/153; 423/625; 264/434; 264/603

(57) ABSTRACT

A kind of transparent alumina ceramics is disclosed herein, the optical axes of all or part of the crystal grains of the transparent alumina ceramics are arranged in a direction, which makes the transparent alumina ceramics have orientation.

### FIELD OF THE INVENTION

The present invention relates to transparent alumina ceramics with oriented grains and manufacture method thereof. The invention belongs to transparent alumina ceramics field.

### TECHNICAL BACKGROUND

Transparent alumina ceramics (also referred to transparent polycrystalline alumina) are of good transmittance with visible light and infrared light, as well as high strength, good heat resistance, improved corrosion resistance, high electrical resistivity, etc., have been widely used as high intensity discharge tubes, infrared windows, high frequency insulating materials, etc. Since Coble [See, U.S. Pat. No. 3,026,210] invented the first piece of transparent alumina ceramics in 1950s, many researchers have devoted themselves to the study of transparent alumina ceramics. A lot of studies have been done in effort to reduce impurities, to eliminate micropores, to control grain boundaries, in order to obtain transparent alumina ceramics with high transmittance. However, it has been proved by half a century's research that traditional measures as described hereinbefore could not be able to inherently improve the transmittance of transparent alumina ceramics essentially.

In fact, α-alumina (corundum) has a hexagonal lattice structure and is optically uniaxial and birefringent. For example, the birefringent index is 0.008 at a wavelength of 600 nm. The phenomena of reflection, refraction and birefringence in the grain boundaries are unavoidable when light transmits between two randomly arranged grains in alumina ceramics. Therefore, the term of transparent alumina ceramics normally refers to translucent alumina ceramics. Consequently, the traditional transparent alumina ceramics can not he used when high transparency is requested, for example laser materials and optical lenses.

In EP1706365, the transmittance of transparent alumina ceramics was greatly improved by means of controlling the average grain size under 1 μm in certain wavelength ranges. But the grain sizes could not be decreased continually into a scale much smaller than the wavelength of visible tight by current techniques. Therefore, the transmittance of the produces reduced dramatically with decreasing wave length in visible light range. That means the birefringence problem of transparent alumina ceramics has not been resolved essentially.

### CONTENTS OF INVENTION

The first object of the invention is to obtain a kind of transparent alumina ceramics to without birefringence problem.

The second object of the invention is to obtain a preparation method of transparent alumina ceramics to solve birefringence problem.

The third object of the invention is to obtain a kind of usage of transparent alumina ceramics.

The forth object of the invention is to obtain another kind of usage of transparent alumina ceramics.

The fifth object of the invention is to obtain polycrystalline alumina transparent ceramic articles.

In the first aspect, the invention provides a kind of transparent alumina ceramics with oriented grains and high in-line transparency. The optical axes of all or part of its grains are arranged in a certain direction, which eliminates the phenomena of reflection, refraction and birefringence in grain boundaries.

In the second aspect, the invention provides a preparation method of transparent alumina ceramics including following process steps:

a) A slurry of dispersed alumina containing optional sintering aid and optional dispersant is formulated firstly.

b) The slurry formulated in step a) is cast and shaped in a strong magnetic field no lower than 1 T, to arrange alumina particles in terms of c axes parallel to the magnetic field direction, and to obtain oriented bodies.

c) After de-molding, the oriented bodies are calcined in air at 600-1200° C., preferably at 800-1200° C.

d) The calcined bodies are then sintered in hydrogen at 1700-1950° C., preferably 1750-1900° C.

In a detailed embodiment, the inventive method is comprised of following process steps:

a) A slurry or dispersed alumina containing sintering aid and dispersant is formulated firstly.

b) The slurry formulated in step a) is slip-cast in a porous mold placed in a strong magnetic field. A layer of wet body is gradually formed, in which c axes of alumina particles are tend to be parallel to magnetic field.

c) After de-molding and drying, the resultant green body is calcined at 800-1200° C. to remove organics.

d) The body is finally fired in hydrogen at 1750-1900° C.

In the third aspect, the invention provides a kind of usage of transparent alumina ceramics as optical lenses and transparent windows.

In the forth aspect, the invention provides a kind of usage of transparent alumina ceramics, the polycrystalline alumina ceramics doped with Cr or Ti ions are functioned as laser media materials or scintillating media materials.

In the fifth aspect, the invention provides a kind of laser ceramic articles manufactured by the transparent alumina ceramics.

### BRIEF DESCRIPTION OF THE DRAWINGS

FIG. 1 is a real object photograph of Ex. 1 which is polished.

FIG. 2 is the XRD patterns of Ex. 1.

FIG. 3 is transmittance results of Ex. 1, Com. Ex. 1 and Com. Ex. 2. The transmittances refer to in-line transmittances of 0.8 mm thick samples.

FIG. 4 is the in-tine transmittance of Ex. 5 on 1 mm thick sample.

FIG. 5 is the in-line transmittance of Ex. 6 on 1 mm thick sample.

FIG. 6 is the in-line transmittance of Ex. 7 on 0.8 mm thick sample.

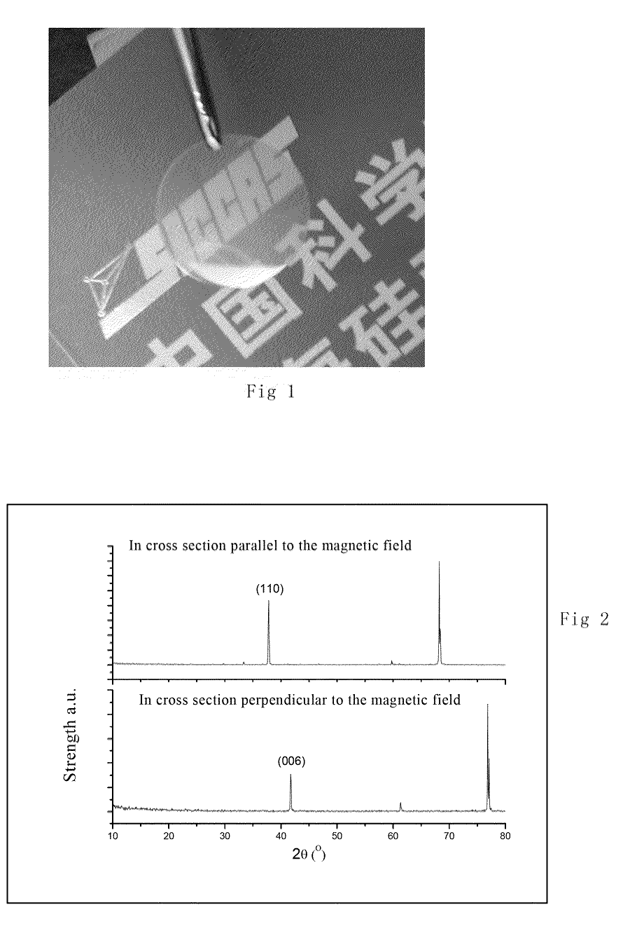

Where:

1 represents the in-line transmittance curve of Ex. 1,

2 represents the in-line transmittance curve of Com. Ex. 1,

3 represents the in-line transmittance curve of Com. Ex. 2,

4 represents the in-line transmittance curve of Ex. 5,

5 represents the in-line transmittance curve of Ex. 6,

6 represents the in-line transmittance curve of Ex. 7.

### PREFERRED EMBODIMENTS OF THE INVENTION

In order to fundamentally solve the problem of the grain boundary reflection, refraction and birefringence, the invention provides a kind of transparent alumina ceramics with oriented grains, in which the optical axes of all or part of the grains are arranged in the same direction, thus improving the transmittance essentially. The invention discloses the preparation method of the transparent alumina ceramics mentioned above as well. The alumina particles suspended in slurry are arranged in terms of c axis parallel to the direction of magnetic field during forming, using a magnetic field stronger than 1 T. After forming, a suitable sintering procedure is conducted. Transparent alumina ceramics with oriented optical axes are obtained, since the optical axis and c axis are parallel to each other for α-alumina.

It was found that the in-line transmittance reaches more than 30% for sample with a thickness of 1 mm, and even near that of single crystal. And for the ultraviolet light of 300 nm, the in-line transmittance remains more than 30%. It was a breakthrough to the present existing techniques. X-ray diffraction analysis reveals that the diffraction peak of (006) plane is enhanced remarkably, while the diffraction peaks of (110) and (300) planes are very weak or even disappear for the cross section originally perpendicular to the magnetic field. In other words, the diffraction peak intensity of (006) plane is 20 times higher than that of (110) or (300) planes. It means c axes of the alumina grains have been oriented successfully in a direction parallel to the magnetic field.

Therefore, the invention provides following technical scenario: to provide a kind of transparent alumina ceramics, in which the optical axes of all or part of its grains are arranged in the same direction.

As used herein, the term of “optical axis” refers to the direction of c axis of alumina crystal.

As used herein, the term of “transparent alumina ceramics” refers to alumina crystal existed in polycrystalline form. The alumina crystal can include traditionally acceptable other components as well, such as various metal ions to impart color, including but not limited to Cr ion or Ti ion. The amount of acceptable other constituents is not specifically defined, provided that it will not limit the objects of the invention.

Since the optical axes (c axis) of all or part of the grains of the transparent alumina ceramics are arranged in the same direction, the alumina grains of the transparent alumina ceramics have preferential orientation in a certain direction. The amount of “all or part of the crystal grain” is sufficient as long as more than 60% of the grains are optical extinction simultaneously under an orthogonal polarizing microscope, preferably more than 70% of the grains, more preferably more than 80% of the grains, further preferably more than 90% of the grains. The optical extinction is generally observed by an orthogonal polarizing microscope. In addition, the person having ordinary skill in the art can make adjustment as desired. For instances, the applicants realized it is possible to attain the effect of elimination of birefringence when more than 50% of the grains are optical extinction.

The technical scenario employed in the invention is as follows.

Well dispersed alumina slurry is formulated firstly. Then it is slip cast in a strong magnetic field. The slurry comprises alumina powders, optional sintering aid and optional dispersant. It shall be considered by the person having ordinary skill in the art that the slurry may contain other acceptable components, provided that it will not limit the objects of the invention. Preferably, the sintering aid is MgO. It is possible to use other traditional sintering aids in the art provided that it will not limit the objects of the invention.

Since the magnetic susceptibility of c axis direction of alumina is greater than those of a and b (x_{c}>xₐ=x_{b}), the c axis of the alumina particles in the suspension are driven to arrange in a direction parallel to the magnetic field. As water is absorbed into mold during the slip casting process, a layer of wet body is gradually formed on the surface of the mold. Hence, the oriented particles are fixed in the green body. After de-molding and drying, the resultant body is then calcined at 800-1200° C. to remove dispersant and other organics therein. Finally, the body is sintered in hydrogen at 1750-1900° C. In addition, it is possible for the one of ordinary skill in the art to appropriately adjust the calcining temperature as desired. The temperatures within the range of 600-1200° C. are generally practicable. Similarly, it is possible for the one of ordinary skill in the art to adjust the sintering temperature as desired. The temperatures within the range of 1700-1950° C. are generally practicable as well.

The X-ray diffraction patterns reveal that the diffraction peak of (006) plane is enhanced remarkably for cross section originally perpendicular to the magnetic field, which demonstrating c axes of the alumina ceramics have been oriented parallel to the magnetic field. With alumina particles varied from disorder to completely oriented, the final transmittance varies gradually. Theoretically, it's acceptable if the magnetic field is stronger than 1 T. 10-20 T is generally preferred.

To disperse the alumina particles sufficiently in the slurry described above herein, it's possible to add dispersant such as ammonium polyacrylate. At the same time, it's also possible to use ultrasonic wave to disperse the particles. The purity of raw alumina powder employed herein is higher than 99.99%. Less than 1 wt % MgO is added as sintering aid. It's apparent to the one of ordinary skill of the art, that it's possible to add MgO in form of salt. The magnesium salt includes but not limits to magnesium nitrate.

Besides sintering aids, suitable amount of Cr or Ti may be added to obtain polycrystalline ruby or polycrystalline sapphire. The amount of Cr or Ti is similar to that of existing technology.

In addition to slip casting described above, it's possible to use other shaping methods conducted in strong magnetic field, such as pressure slip casting, gel casting, or electrophoretic deposition, and so on. Additionally, plaster slip casting is appropriate as well herein. Besides the sintering methods described above, the methods similar to those disclosed in Chinese patent ZL 02123648.8 and Chinese Patent ZL 200510115465.2 are applicable as well. The calcined body is pre-sintered at 1200-1400° C. first to obtain a relative density higher than 95%. Then sintered under isostatic pressure to obtain transparent ceramics.

The in-line transmittance at 650 nm of the resultant transparent alumina ceramics reaches high than 50%, up to 76%, or even near to that of single crystal, which is better than that made by existing technical methods.

In a detailed embodiment, the in-line transmittance of a 1.0 mm thick sample obtained herein is 30% or higher.

In a detailed embodiment, all or more than 50% of the crystal grains within the viewing area of cross polarized microscope are optical extinction simultaneously.

In a detailed embodiment, the transparent ceramics containing Cr ions show the absorption peaks of Cr ion near 410 nm and 560 nm. The ultraviolet absorption edge of the transparent ceramics containing Ti ion is shifted to the wavelength around 280 nm.

The transparent alumina ceramics obtained herein can be used as optical lenses, transparent windows, etc. The transparent alumina ceramics doped with Cr or Ti ions can be applied as laser media materials or scitinlliting media materials instead of existing ruby single crystal or sapphire single crystal.

The present invention will be further illustrated in connection with specific examples. It's to he understood these examples are solely functioned to illustrate the invention but not to limit its scope. The experimental methods of following examples without detailed conditions noted are generally in according to common practice, such as those in Beilstein Handbuch der Organischen Chemie (Chemical Industry Publisher, 1990, or the conditions recommended by manufacturers. Ratios and percentages are based on weight, unless it's specified otherwise.

Unless there are other definition or explanation, all of the professional and scientific terminologies employed herein have the same meaning as that the one of ordinary skill in the art familiar with. Furthermore, all of the methods and materials similar or equivalent to what have been described herein are applicable to the inventive method.

### Example 1

The average particle size of the alumina powder used was 0.5 μm. And the purity was 99.99%. 5000 g alumina powder, 1500 g water, 6.4 g magnesium nitrate hexahydrate (the amount relative to sintering aid MgO is 200 ppm) were homogeneously mixed. After dry, the mixture was heated to 600° C. The resultant powder was ground with alumina mortar, and sieved for later use.

The alumina powder containing MgO prepared above was added into deionized water with the solid loading of 30 vol %. Ammonium polyacrylate with the amount of 0.5 wt % relative to the alumina powder was added as dispersant. The mixture was ball milled and then dispersed with the help of ultrasonic wave for 30 minutes to obtain homogeneously dispersed suspension.

A plaster mold with a cylindrical pit in the middle was placed horizontally into a 12 T vertical uniform magnetic field. The cylindrical pit was filled with homogeneously dispersed suspension described above. The mold was moved out and demolded after 120 minutes. The wet body obtained after demolding was baked to dry and calcined in air at 1000° C. for 2 hours to remove organics. The bottom layer about 1 mm was cut to prevent plaster contamination. Finally, the calcined body was sintered in hydrogen at 1850° C. for 3 hours.

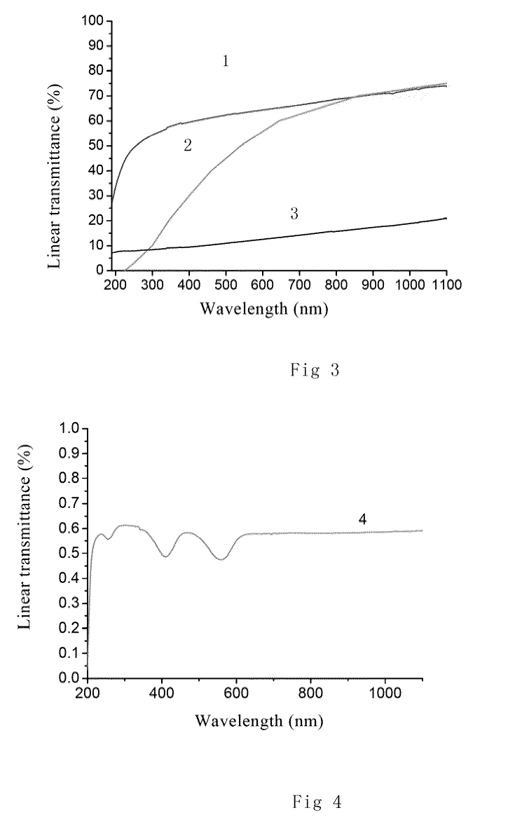

The resultant sintered body was cut and polished to a small plate with a thickness of 0.8 mm. The in-line transmittance measured at 650 nm (FIG. 3, curve 1) reached 65%, varied quite little in visible light hand with wavelength.

The transparent alumina ceramics thus obtained were analyzed with X-ray diffraction result. It revealed in FIG. 2 that the diffraction peak of (006) plane was enhanced remarkably, while the diffraction peaks of (110) and (300) planes were very weak or even disappeared for the cross section originally perpendicular to the magnetic field. For the cross section parallel. to the magnetic field, the diffraction peaks of (110) and (300) were remarkably enhanced, while the peak of (006) disappeared. It's demonstrated that the c axes of the grains were oriented in a direction parallel to the magnetic field.

The transparent alumina ceramics thus obtained was sampled along one direction parallel to the magnetic field and the other direction perpendicular to the magnetic field respectively, and processed to 0.03 mm thick flakes respectively to be observed by orthogonal polarizing microscope. For the flakes perpendicular to the magnetic field, more than 90% of the viewing area of the cross polarized microscope showed complete optical extinction except for a few grains, which demonstrated that the optical axes were perpendicular to the flakes. For the flakes parallel to the magnetic field, more than 90% grains showed optical extinction for 4 times at the same time, when rotating the specimen stage in 360° under orthogonal polarizing light.

### Comparative Example 1

The same method was applied to the samples prepared in according to EP1706365, with the resultant in-line transmittance (FIG. 3, curve 2) decreased quickly as wavelength diminished.

### Comparative Example 2

To compare the effect of the magnetic field, the homogeneously dispersed suspension in example 1 was molded in a condition without magnetic field, with the other preparation conditions the same as those of example 1. The in-line transmittance of the resultant sintered body under the same test conditions (FIG. 3, curve 3) was less than 20%.

### Comparative Example 3

The same measure was applied to the samples prepared in according to ZL02123648.8. The in-line transmittance (2) decreased quickly as wavelength diminished.

### Comparative Example 4

To compare the effect of the magnetic field, the homogeneously dispersed suspension in example 1 was slip cast in a condition without magnetic field, while other preparation conditions are the same as those of example 1. The in-line transmittance (3) of the sintered body under the same test conditions was less than 20%.

### Example 2

The alumina powder used was the same as that of example 1. 5000 g alumina powder, 1500 g water, 6.4 g magnesium nitrate hexahydrate, 13.2 g chromium nitrate nonhydrate (the content of Cr₂O₃ relative to alumina is 0.05 wt %) were homogeneously mixed, baked to dry, then heated to 600° C. to calcine it, giving the alumina powder containing 200 ppm MgO and 0.05 wt % Cr₂O₃. The resultant powder was ground with alumina mortar for later use.

The preferential orientation, molding procedures were the same as those of example 1, finally sintered in hydrogen at 1820° C. for 3 hours. The resultant transparent alumina ceramics doped with Cr (alas referred to polycrystalline ruby) appeared with a color of pink, the in-line transmittance at 650 nm reaches 58%.

The polycrystalline ruby thus obtained was analyzed with X-ray diffraction result. In cross section perpendicular to the magnetic field, the diffraction peak of (006) crystal plane of the polycrystalline ruby was remarkably enhanced, with no diffraction peak of (110) crystal plane appeared: in cross section parallel, to the magnetic field, the diffraction peak of (110) crystal plane of the polycrystalline ruby was also very strong, with no diffraction peak of (006) crystal plane appeared.

The polycrystalline ruby thus obtained was processed to 0.03 mm thick flakes, observed under orthogonal polarizing microscope. For the flakes parallel to the magnetic field, as rotating the specimen stage in 360° under cross polarized light, the flakes showed optical quenching for 4 times, and more than 60% of the crystal grains optical quenched when rotated to the same angle, which demonstrated that part of the optical axis have preferential orientation.

### Example 3

The average particle size of the alumina powder used was 0.15 μm, the purity was 99.99%. 5000 g alumina powder, 92.6 g 10 wt % titanium nitrate solution, 1500 g water were homogeneously mixed, baked to dry, then heated to 500° C. to calcine it, giving the alumina powder containing 0.05 wt % TiO₂. The resultant powder was ground with alumina mortar for later use.

150 g alumina powder containing TiO₂ described above and 50 g 15 wt % glycerin glycidyl ether were mixed, with 1 ml ammonium polyacrylate added as dispersant, ball milled for 2 hours, then dispersed with the help of ultrasonic wave for 30 minutes to obtain homogeneously dispersed suspension.

As soon as 2.5 ml 3,3′-Diaminodipropylamine was added into the suspension described above, the suspension was pumped to remove bubbles, with stirring at the same time. After 2-5 minutes, the mixed slurry with bubbles removed was injected into stainless steel mold, which was put in a 20 T magnetic field. The mold was removed out 2 hours later, and demolded to obtain wet body. The wet body was baked to dry and heated slowly to 1300° C. to remove organics, giving a density of more than 95% of theoretical density (TD), finally fired under isostatic pressure of 200 MPa at 1275° C. for 3 hours to yield light blue transparent alumina ceramics doped with Ti (also referred to polycrystalline sapphire doped with Ti).

In according to the test method or example 1, the in-line transmittance measured at 650 nm was 72%.

The resultant polycrystalline sapphire doped with Ti obtained above was analyzed with X-ray diffraction result. In cross section perpendicular to the magnetic field, the diffraction peak of (006) crystal plane of the polycrystalline sapphire was remarkably enhanced, with very weak diffraction peak of (110) crystal plane (similar to FIG. 2).

For the flakes parallel to the magnetic field, as rotating the specimen stage in 360° under cross polarized light, the flakes showed optical quenching for 4 times, and more than 80% of the crystal grains optical quenched when rotated to the same angle, which demonstrated that part of the optical axis had preferential orientation.

### Example 4

The raw materials and the formulation method of the suspension were the same as those of example 1.

The electrophoretic deposition was applied for molding, with the flat electrodes placed horizontally, the magnetic field perpendicular to the flat electrodes, the magtitude of the magnetic field was 14 T. The firing procedures after molding were the same as those of example 1, with the test methods the same as those of example 1.

The in-line transmittance at 650 nm of the resultant sample was 76%, in cross section perpendicular to the magnetic field, the diffraction peak of (006) crystal plane of the polycrystalline alumina was remarkably enhanced, with very weak diffraction peak of (110) crystal plane (similar to FIG. 2).

For the flakes parallel to the magnetic field, as rotating the specimen stage in 360° under cross polarized light, the flakes showed optical quenching for 4 times, and more than 70% of the crystal grains optical quenched when rotated to the same angle, which demonstrated that part of the optical axis had preferential orientation.

### Example 5

The alumina powder used was the same as that of example 1. 5000 g alumina powder, 1500 g water, 6.4 g magnesium nitrate hexahydrate, 39.5 g chromium nitrate nonhydrate (the content of Cr₂O₃ relative to alumina was 0.3 wt %) were homogeneously mixed, baked to dry, then heated to 600° C. to calcine it. The resultant powder was ground and sieved for later use.

The molding and calcining procedures were the same as those of example 1. The sintering was conducted in a vacuum furnace at 1850° C. for 5 hours. The resultant transparent alumina ceramics doped with Cr (also referred to polycrystalline ruby) appeared with a color of pink. The in-line transmittance of the 1 mm thick polished samples at 300-1000 nm was more than 55%. The absorption peaks of Cr ions appeared near 410 nm and 560 nm.

The resultant polycrystalline ruby obtained above was analyzed with X-ray diffraction result. For the cross section perpendicular to the magnetic field, the difraction peak of (006) crystal plane was remarkably enhanced, while no diffraction peaks of (110) and (300) crystal plane appeared. For the cross section parallel to the magnetic field, the diffraction peaks of (110) and (300) crystal plane were very strong, while no diffraction peak of (006) crystal plane appeared.

The polycrystalline ruby thus obtained was processed to 0.03 mm thick flakes, observed under orthogonal. polarizing microscope. For the flakes parallel to the magnetic field, as rotating the specimen stage in 360° under orthogonal polarizing light, the flakes showed optical extinction for 4 times. And more than 70% of the crystal. grains showed optical extinction at the same angle when rotating the flakes.

### Example 6

The raw materials were the same as those of example 1 and with no treatment. The suspension was formulated in according to the method of example 1. The electrophoretic deposition was applied for molding. The flat electrodes were placed horizontally in a vertical 14 T uniform magnetic field. The green body was fired in air at 1000° C. for 2 hours, yielding some strength. 7.8 g magnesium nitrate hexahydrate was dissolved in 2000 ml. Then, the calcined green body was put into the solution for over 24 h. After baking, the doped body was calcined in air at 1000° C. for 2 hours, followed by final sintering in vacuum furnace in according to the method of example 5.

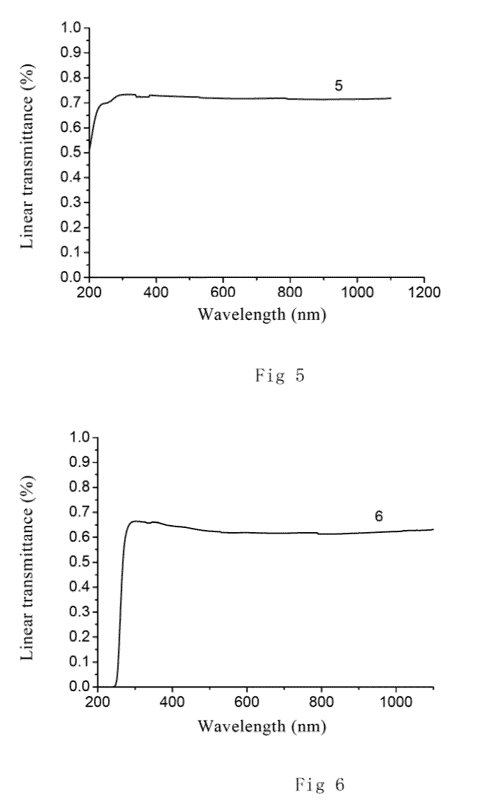

After polish, the in-line transmittance of 1 mm thick sample (FIG. 5) reached 70%. For the cross section perpendicular to the magnetic field, the diffraction peak of (006) crystal was remarkably enhanced, while the diffraction peaks of (110) and (300) crystal plane were very weak. For the ultrathin flake parallel to the magnetic field, as rotating the specimen stage in 360° under orthogonal polarizing light, the flake showed optical extinction for 4 times. And more than 80% of the crystal grains showed optical extinction at the same angle when rotating the flakes.

### Example 7

A commercial TM-DAR alumina powder was applied, which had an average particle size of 0.15 μm and a purity of 99.99%. 180 g alumina powder described above and 50 g 15 wt % glycerin glycidyl ether, with 1 ml ammonium polyacrylate added as dispersant, were mixed and then treated by ultrasonic wave for 30 minutes to obtain homogeneously dispersed suspension.

As soon as 2.5 ml 3,3′-Diaminodipropylamine was added into the suspension described above, the suspension was pumped to remove bubbles, with stirring at the same time. After 2-5 minutes, the mixed slurry was filled into stainless steel mold, which was put in a 14 T magnetic field. The mold is removed out after 3 hours rest. After demolding, the wet body was baked to dry and heated slowly to 700° C. to remove organics.

19 g magnesium nitrate hexahydrate and 18 g titanium sulfate were dissolved in 2000 ml water. The pre-calcined green body was put into the solution for 24 hours, removed out and then baked to dry. The body was heated slowly to 1300° C. and remained at that temperature for 2 hours, to obtain a presintered body with a density of more than 95 % TD. Final sintering was conducted by HIP under isostatic pressure of 200 MPa and at 1275° C. for 3 hours to obtain the transparent alumina ceramics doped with Ti (also referred to polycrystalline sapphire doped with Ti). The in-line transmittance of 1 mm thick polished sample (FIG. 6) was more than 60%. The resultant polycrystalline sapphire doped with Ti obtained above was analyzed with X-ray diffraction result. For the cross section perpendicular to the magnetic field, the diffraction peak of (006) crystal plane was remarkably enhanced, while the diffraction peaks of (110) and (300) crystal plane were very weak. For the ultrathin flake parallel to the magnetic field, as rotating the specimen stage in 360° under orthogonal polarizing light, the flake showed optical extinction for 4 times. And more than 60% of the crystal grains showed optical extinction at the same angle when rotating the flakes.

1. A kind of transparent alumina ceramics, wherein the optical axes of all or part of the crystal grains of the transparent alumina ceramics are arranged in a direction.

2. The transparent alumina ceramics of claim 1, wherein the arrangement of the optical axes is achieved by a magnetic field which is stronger than 1 T.

3. The transparent alumina ceramics of claim 2, wherein the strong magnetic field is or 10-30 T.

4. The transparent alumina ceramics of claim 2, wherein the strong magnetic field is of 10-20 T.

5. The transparent alumina ceramics of claim 2, wherein for the cross section perpendicular to the magnetic field, the diffraction peak of (006) crystal plane is remarkably enhanced, while no diffraction peak of (110) crystal plane appears.

6. The transparent alumina ceramics of claim 5, wherein the diffraction peak of (006) has an intensity of 20 times greater than that of (110) crystal plane or (300) crystal plane.

7. The transparent alumina ceramics of claim 5, wherein at least 60% of the crystal grains has optical extinction simultaneously.

8. The transparent alumina ceramics of claim 5, wherein it further contains doped Cr or Ti ions.

9. The preparation method of the transparent alumina ceramics of claim 1, wherein comprises of following steps:
a) Providing a slurry of dispersed alumina containing optional sintering aid and optional dispersant,
b) Casting and Shaping the slurry of step a) in a strong magnetic field no lower than 1 T, to arrange alumina particles in terms of c axes parallel to the magnetic field direction, and to obtain oriented bodies,
c) De-molding the oriented bodies of step b) and calcining in air at 600-1200° C.,
d) Sinstering the calcined bodies of step c) in hydrogen at 1700-1950° C. to obtain the transparent alumina ceramics.

10. The method of claim 9, wherein the bodies of step c) is calcined at 800-1200° C.

11. The method of claim 9, wherein the calcined bodies in step d) is fired at 1750-1900° C.

12. The method of claim 9, wherein the sintering aid is MgO.

13. The method of claim 9, wherein the dispersant is ammonium polyacrylate.

14. The method of claim 9, wherein the molding method is one or slip casting, pressure casting, gel-casting, or electrophoretic deposition.

15. The usage of the transparent alumina ceramics of claim 1, wherein it functioned as optical lenses, transparent windows.

16. The usage of the transparent alumina ceramics of claim 1, wherein the polycrystalline alumina ceramics doped with Cr or Ti ions functioned as laser media materials or scintillating media materials.

17. A kind of laser ceramic article prepared from the transparent alumina ceramics of claim 1.
